(19) United States
(12) Patent Application Publication
(10) Pub. No.: US 2025/0091137 A1
(43) Pub. Date: Mar. 20, 2025

(54) CLAMPING DEVICE

(71) Applicant: FCS SYSTEM SRL, Casale sul Sile (IT)

(72) Inventors: Andrea CALZAVARA, Silea (IT); Nico TREVISIOL, Maserada sul Piave (IT)

(21) Appl. No.: 18/822,517

(22) Filed: Sep. 3, 2024

(30) Foreign Application Priority Data
Sep. 15, 2023 (IT) 102023000019062

(51) Int. Cl. B23B 31/16

(52) U.S. Cl. CPC B23B 31/16

(57) ABSTRACT

Clamping device comprising a first connection body having a locking portion slidably inserted in a guide seat, which is obtained in a second connection body, so that the first and the second connection body are slidably associated to translate one with respect to the other in a plurality of adjustment positions. The locking portion is deformable between an expanded configuration, in which it exerts a pressure against a lateral surface delimiting the guide seat, and an undeformed configuration, in which it does not exert pressure allowing the first connection body to slide. A locking system is provided to act on the locking portion to deform it between the expanded and the undeformed configuration. Said locking system is moved by an actuating piston slidably inserted in a guide chamber obtained in the first connection body.

### FIELD OF THE INVENTION

The present invention relates to a clamping device for holding a semifinished product in position with respect to a support base, according to the preamble of the independent claim 1.

In particular, the clamping device in question is advantageously used in the mechanical industry so as to hold in position bodies designed to be subjected to various processing operations.

More particularly, the clamping device subject of the present invention can be advantageously used to hold in position, with respect to the support base, in particular of a machine tool (for example of the CNC type), a body to be processed, which is advantageously made of metal material, or made of composite material, or made of any other material.

Therefore, the invention relates to the industrial field of precision mechanics.

### STATE OF THE ART

In the field of processing mechanical components through turning operations, milling operations, drilling operations etc. there particularly arises the need for stably holding the semi-finished products to be processed.

To this end, the clamping devices of the known type are generally fixed to a support base, usually coupled to or part of a machine tool for processing semi-finished products. In particular, the support bases of the known type are provided with a plurality of seats, in particular threaded, for fixing the clamping device, the fixing seats being distributed along a matrix of points to determine a plurality of pre-established operative positions in which the clamping device can be arranged to support the semi-finished product, available for the machine tool.

In greater detail, the clamping devices of the known type are generally fixed, on one side, to the support base and, on the other side, to the semi-finished product to be retained, and in particular they are interposed between each other. In order to be fixed to the semi-finished product and to the support base, the clamping devices of the known type are generally provided with fixing means comprising tensioners, the tensioners particularly consisting of a first threaded rod screwed to the semi-finished product and of a second threaded rod screwed to the support base. The two threaded rods of the fixing means are further partially inserted inside corresponding housing seats obtained in the central body of the clamping device and they are locked to the latter using anchoring means, usually comprising a pair of a pair of jaws adapted to act on each threaded rod. In particular, the jaws of the anchoring means of the known type are generally slidably mounted on the central body with a corresponding one of the first and the secure threaded rod of the fixing means being interposed and they can be actuated to slide approaching each other, for example through a screw-and-nut mechanism, to close on the threaded rod in question and, therefore, clamp and secure it to the central body of the clamping device.

In greater detail, the clamping is carried out stably given that the jaws of the anchoring means and the portion of the threaded rods designed to be interposed between the jaws mentioned above are shaped so that, when the jaws are closed, the latter exert forces which, being discharged through the threaded rods, on the one hand, pressure-pull the central body of the clamping device against the support base and, on the other hand, pressure-pull the central body mentioned above against the semi-finished product.

However, the devices for clamping semi-finished products of the known type briefly described above revealed some practical drawbacks.

A main drawback of the clamping devices of the known type lies in the inability to precisely adjust the position in which such clamping devices are connected to the semi-finished product to be held in position. As a matter of fact, holding a semi-finished product to the base requires using a set made up of multiple clamping devices, all of which are provided with a substantially cylindrical-shaped main body which extends between two bases which are parallel to each other, one designed to rest against the base and one designed to rest against the semi-finished product, and all of them have the same height. However, it is clear that the surface of the semi-finished product arranged counter-faced to the base, or the surface on which there are obtained the threaded seats designed to be engaged by elements for tensioning the clamping devices, may not be a perfectly planar surface and could therefore have uneven geometric tolerances along the entire extension thereof. Therefore, the points where the threaded seats are provided could be arranged at slightly different distances from the support base or the threaded seats mentioned above could have inclinations that are slightly different from each other. As a result, when there is used a set of clamping devices according to the prior art to hold in position a semi-finished product (in the set all the clamping devices having the same shape and sizes) and the threaded rods of each device being clamped by using jaws of the anchoring means, there are generated pulling or compression stresses at least in the area adjacent to the threaded seats engaged by the rods, the stresses increasing proportionally as the as the difference between the height of the clamping device and the distance of the corresponding threaded seat from the base increases and it could affect the quality of the processing operations carried out on the semi-finished product.

A further drawback of the clamping devices of the known type lies in their inability to adapt to semi-finished products provided with uneven shapes, for example provided with outer surfaces which, once the semi-finished product has been released from the support base, are inclined with respect to the support base and which are non-planar.

### SUMMARY OF THE INVENTION

In this situation, the technical problem underlying the present invention is therefore to overcome the drawbacks of the prior art, by providing a clamping device for holding a semifinished product in position with respect to a support base, which allows it to adapt to the particular height of the point where the semi-finished product is clamped and/or to the inclination of the surface of the semi-finished product at the point where the semi-finished product mentioned above is clamped.

A further object of the present invention is to provide a clamping device, which avoids the onset of unwanted pulling and compression stresses on the semi-finished product to be fixed to the support base.

A further object of the present invention is to provide a clamping device, which allows to eliminate any unwanted pulling and compression stresses which developed in the semi-finished product during the mechanical processing steps to which the semi-finished product has been subjected.

A further object of the present invention is to provide a clamping device, which is operatively entirely reliable.

A further object of the present invention is to provide a clamping device, that is simple and cost-effective to manufacture and use.

### BRIEF DESCRIPTION OF THE DRAWINGS

The technical characteristics of the invention, according to the objects mentioned above, are clearly observable from the content of the claims outlined below and the advantages thereof will be more apparent from the detailed description below, provided with reference to the attached drawings, which represent an embodiment thereof provided purely by way of non-limiting example, wherein:

FIG. 1 shows a perspective view of a clamping device subject of the present invention according to a first embodiment;

FIG. 2 shows a top plan view of the clamping device of FIG. 1;

FIG. 3 shows a lateral cross-sectional view of the clamping device of FIG. 1, the section being obtained along the line III-III of FIG. 2;

FIG. 4 shows a perspective view of a part of a first connection body of a first clamping assembly of the clamping device of FIG. 1;

FIG. 5 shows a lateral cross-sectional perspective view of the part of FIG. 4;

FIG. 6 shows a perspective view of a second belleville washer of a second elastic member of the clamping device, both according to the first embodiment and according to the second embodiment shown in FIGS. 7 to 10;

FIG. 7 shows a perspective view of a clamping device subject of the present invention according to a second embodiment;

FIG. 8 shows a top plan view of the clamping device of FIG. 7;

FIG. 9 shows a lateral cross-sectional view of the clamping device of FIG. 1, the section being obtained along the line IX-IX of FIG. 8;

FIG. 10 shows a lateral cross-sectional perspective view of a part of the first connection of the clamping device of FIG. 7, the section being obtained along the line IX-IX of FIG. 8.

### DETAILED DESCRIPTION OF A PREFERRED EMBODIMENT

With reference to the attached drawings, a clamping device according to the present invention has been indicated in its entirety with 1.

Such clamping device 1 is advantageously intended to be used for holding a semifinished product in position with respect to a support base, and in particular it is intended to maintain the semi-finished product at a pre-established position available for processing operations to which it is designed to be subjected.

In greater detail, the support base may belong to an operating machine, such as for example a CNC operating machine, provided to subject the semi-finished product to processing operations, such as for example chip removal operations (milling, surface finish treatments, drilling, etc.).

Otherwise, the support base may be a different component with respect to the operating machine, the component being intended to be installed adjacently to the latter and it is provided to maintain, through the clamping device 1 subject of the present invention, the semi-finished product in position with respect to a tool device of the operating machine mentioned above.

According to the invention, the clamping device 1 comprises at least one first clamping assembly 2, which is intended to be removably fixed to one of the support bases and the semi-finished product comprises at least one first connection body 3.

In greater detail, the first clamping assembly 2 is advantageously provided with first coupling means 34 provided to removably fix the first clamping assembly 2 mentioned above to the support base or to the semi-finished product.

Preferably, the first coupling means 34 are threaded in order to be able to removably fix the first clamping assembly 2 to the support base or to the semi-finished product.

As a matter of fact, conventionally, the semi-finished product is provided with first threaded holes at the points where it should be clamped to the support base and the support base is provided with a plurality of second threaded holes distributed along a regular matrix of points, so as to be able to select the second hole in the position most suitable for clamping the semi-finished product to the support base through the clamping device 1 in question.

Therefore, this allows to facilitate fixing by screwing the first clamping assembly 2 to the support base or to the semi-finished product using the first threaded coupling means 34.

Furthermore, the clamping device 1 in question comprises at least one second clamping assembly 4, which is intended to be removably fixed to the other of the semi-finished product and the support base and comprises at least one second connection body 5.

Such first and second connection body 3, 5 are mechanically engaged to mutually move one with respect to the other between a plurality of first adjustment positions.

In greater detail, the second clamping assembly 4 is advantageously provided with second coupling means 35 provided to removably fix the second clamping assembly 4 mentioned above to the support base or to the semi-finished product, that is in particular to the one to which the first clamping assembly 2 is not removably fixed.

Preferably, the second coupling means 3 are threaded in order to be able to removably fix the second clamping assembly 4 to the support base or to the semi-finished product.

Therefore, this allows to facilitate the fixing by screwing the second clamping assembly 4 to the support base or to the semi-finished product through second threaded coupling means 35 (given that, as explained above, the semi-finished product and the support base are respectively conventionally provided with first and second threaded holes).

In addition, the clamping device 1 according to the invention comprises a first locking system 6, which is mechanically associated with the first and the second connection body 3, 5 and it can be switched between a first constraint condition in which it locks the first and the second connection body 3, 5 into one of the first adjustment positions, and a first release condition, in which it frees the first and second connection body 3, 5 to mutually move one with respect to the other.

The clamping device 1 in question further comprises a first actuation piston 7, which is slidably inserted into a first guide chamber 8 obtained on the first connection body 3 to translate between a first actuation position, in which it maintains the first locking system 6 in the first constraint condition, and a second actuation position, in which it maintains the first locking system 6 in the first release condition.

The clamping device 1 in question comprises a first elastic member 9, which is inserted into the first guide chamber 8 and it is provided to force the first actuation piston 7 into one of the first actuation position and the second actuation position, and a first actuator 10, which is provided to move the first actuation piston 7 into the other of the first and the second actuation position making the first elastic member 9 yield elastically.

In greater detail, providing the first elastic member 9 in the first guide chamber 8 ensures that the first actuation piston 7 is always maintained in one of the first and the second actuation position, so as to respectively maintain the first locking system 6 in the first constraint condition or in the first release condition, while providing the first actuator 10, which may be actuated to make the first elastic member 9 yield elastically, allows to move the actuation piston 7 into the other of the first and the second actuation position to switch the first locking system 6, therefore locking or releasing the relative displacement between first and second connection body 3, 5 depending on the needs.

In this manner, operatively, when the semi-finished product is fixed to the support base by means of multiple clamping devices 1, it is possible to act on the first actuator 10 (actuating or disabling them depending on whether the first elastic member 9 forces the first actuation piston 7 in the first or second actuation position) so as to ensure that, during a processing operation (for example removal of chips, finishing, milling, drilling and the like), the first actuation piston 7 is in the first position to maintain the first locking system 6 in the first constraint condition, resulting in the fact that during such processing operation the first and second connection body 3, 5 are in a specific first adjustment position and precisely hold the semi-finished product in position with respect to the support base. Furthermore, operatively, once the processing operation mentioned above has terminated, still acting on the first actuator 10, it is possible to move the first actuation piston 7 in the second actuation position to switch the first locking system 6 in the first release position, so that the first and second connection body 3, 5 can settle in a different first adjustment position compensating for possible pulling and/or compression stresses which developed in the semi-finished product during the processing operation, for example due to thermal deformations and the like. Therefore, advantageously, the switching of the first locking system 6 in the first release condition by means of the first actuation piston 7, which is moved through the first elastic member 9 and the first actuator 10, ensures that the semi-finished product is free of compression and/or pulling stresses following any processing operation, so that the semi-finished product mentioned above can be subjected, after the first locking system 6 have been returned to the first constraint condition, to another subsequent processing operation without any possible compression and/or pulling stresses affecting the quality thereof.

In order to allow an easy production of the device 1 in question, the first connection body 3 advantageously comprises a first component 3′ and a second component 3″, which are fixed to each other (for example using screws or by welding) and together delimit the first guide chamber 8.

In this manner, when manufacturing the device 1 according to the invention, it is sufficient to introduce the first actuation piston 7 and the first elastic member 9 in a cavity obtained on one of the first and the second component 3′, 3″ and adapted to at least partially define the first guide chamber 8 when the first and the second component 3′, 3″ are fixed and, subsequently, fix the first and the second component 3′, 3″ to each other using screws or by welding so as to delimit the guide seat 8 containing at least the first actuation piston 7 and the first elastic member 9 therein.

As shown in the attached drawings, preferably, the first guide chamber 8 extends mainly (in particular only) inside the first component 3′ and the second component 3″ is fixed to the first component 3′ (for example through screws or by welding) to close the first guide chamber 8 mentioned above, so that the first guide chamber 8 is delimited both by the first and by the second component 3′, 3″.

Advantageously, according to the embodiments shown in the attached figures, the first elastic member 9 is provided to force the first actuation piston 7 in the first actuation position and the first actuator 10 is provided to move the first actuation piston 7 in the second actuation position making the first elastic member 9 yield elastically.

In this manner, the first elastic member 9 automatically maintains the first locking system 6 in the first constraint condition forcing the first actuation piston 7 in the first actuation position, so that the first and second connection body 3, 5 are constantly maintained in a specific first adjustment position during the entire carrying out of the processing operations. Furthermore, in this manner, it is sufficient to act on the first actuator 10 briefly only at the end of the processing operations mentioned above to switch the first locking system 6 in the first release condition and allow the mutual movement of the first and second connection body 3, 5 so as to compensate for any compression and/or pulling stresses that developed.

Preferably, the first elastic member 9 comprise at least one first belleville washer 36 and, even more preferably, a plurality of first belleville washers 36 arranged on each other.

In particular, the use of the at least one first belleville washer 36 is particularly advantageous with the first elastic member 9 which is provided to push the first actuation piston 7 in the first actuation position (such as for example in the first and second shown embodiment). As a matter of fact, the first belleville washers 36 generally have a stiffness greater than that of the helical springs and therefore, in this case, they are able to maintain he first locking system 6 in the first constraint condition with greater safety, so as to prevent the stresses transmitted to the semi-finished product during the processing operations from causing the first and the second connection body 3, 5 from moving with respect to each other changing the first adjustment position in an unwanted manner.

Advantageously, the first actuator 10 comprises at least one first conveyance duct 32 obtained on the first connection body 3, placed in fluid communication with the first guide chamber 8 and designed to convey a pressurised fluid against the first actuation piston 7 to make the first elastic member 9 yield elastically and push the first actuation piston 7 into the other of the first actuation position and the second actuation position.

In particular, such conformation of the first actuator 10 with first conveyance duct 32 makes the clamping device 1 in question particularly simple, given that in order to make the first elastic member 9 yield elastically, it is sufficient to connect the first conveyance duct 32 mentioned above to means for supplying a pressurised fluid, which can for example be a compressed air or pressurised oil supply circuit (normally available for any company or workshop operating in the mechanical industry), and actuate the supply means mentioned above when needed.

In greater detail, the first actuation piston 7 is provided with a first face 7′ and with an opposite second face 7″.

Furthermore, preferably, the first actuation means 9 are arranged abutting against the first face 7′ mentioned above and the first actuator 10 is provided to make the first elastic member 9 yield elastically by acting on the second face 7″.

In particular, the first conveyance duct 32 of the first actuator 10 is provided to convey the pressurised fluid against the second face 7″ so as to make the first elastic member 9 yield elastically.

Preferably, the first guide chamber 8 is delimited by a first end surface 8′, which is arranged counter-faced to the first face 7′ of the first actuation piston 7, and by an opposite second end surface 8″, which is arranged counter-faced to the second face 7″ of the first actuation piston 7.

In addition, the first guide chamber 8 is also preferably delimited by an inner lateral surface 8′″, which extends from the first end surface 8′ to the second end surface 8″ to enclose the first guide chamber 8 therewith.

In greater detail, the first actuation piston 7 is provided to translate in the first guide chamber 8 between the first and the second actuation position along the movement direction thereof.

Furthermore, the first and the second end surface 8′, 8″ of the first guide chamber 8 are, preferably, transversal to the movement direction and, more particularly, orthogonal to the movement direction mentioned above.

In particular, the first elastic member 9 is interposed between the aforementioned first end surface 8′ and the first face 7′ of the first actuation piston 7.

In greater detail, the conveyance duct 32 mentioned above extends between a receipt opening 32′, which is arranged on an outer lateral surface 57 of the first connection body 3, and a conveyance opening 32″, which is placed in fluid connection with the first guide chamber 8, in particular arranged on the inner lateral surface 8′″ adjacently to the second end surface 8″ or at least partly directly obtained on the second end surface 8″ (according to embodiments not shown in which there are no other actuation pistons and other elastic members in the first guide chamber 8), or obtained on the lateral surface 8′″ spaced both from the first and the second end surface 8′, 8″ (according to the shown embodiments in which, as better described below, another actuation piston and other elastic member are present in the first guide 8).

Furthermore, the first actuation piston 7 advantageously carries mounted thereon at least one elastic gasket, which, in greater detail, prevents the pressurised fluid introduced by the first conveyance duct 32 in the portion of the first guide chamber 8 which extends between the second end surface 8″ and the second face 7″ of the first actuation piston 7 from seeping in the portion of the first guide chamber 8 which extends between the first end surface 8′ and the first face 7′.

In particular, the at least one elastic gasket mentioned above is pressed against the inner lateral surface 8′″ of the first guide chamber 8, so as to prevent the pressurised fluid supplied by the first conveyance duct 32 from seeping on the sides of the first actuation piston 7.

According to the idea underlying the present invention, the first and the second connection body 3, 5 are slidably associated along a translation direction to move one with respect to the other in the plurality of the first adjustment positions.

In greater detail, the fact that the first and the second connection body 3, 5 are slidably associated along the translation direction ensures that the clamping device 1 in question can be used for clamping to the support base of the semi-finished products having a clamping surface (facing towards the support base) with uneven dimensional tolerances, which carry at different distances from the support base the various points in which the clamping devices 1 will be clamped to the semi-finished product.

Still, according to the idea underlying the present invention, the second connection body 5 is provided with a guide seat 19 at least partially internally delimited by a first lateral surface 20 and the first connection body 3 is at least partially inserted into said guide seat 19 slidably along the translation direction.

Furthermore, the first connection body 3 is provided with a locking portion 21 contained in said guide seat 19 and it is deformable between an expanded configuration, in which it exerts a pressure against the first lateral surface 20 to prevent the first connection body 3 from sliding into said guide seat 19, and an undeformed configuration, in which it does not exert pressure against the first lateral surface 20 allowing the first connection body 3 to slide in the guide seat 19.

In this manner, when the locking portion 21 is in expanded configuration, the first and the second connection body 3, 5 are prevented from sliding one with respect to the other along the translation direction by the friction force exerted by the locking portion 21 against the first lateral surface 20 of the guide seat 19 of the second connection body 5.

Therefore, in greater detail, the first locking system 6 is provided to maintain the locking portion 21 of the first adjustment body 3 in the expanded configuration when it is in the first constraint condition and it is provided to maintain the locking portion 21 in the undeformed configuration when it is in the first release condition.

Advantageously, in order to allow the locking portion 21 to switch between the expanded configuration and the undeformed configuration in the easiest manner possible, the locking portion 21 mentioned above of the first connection body 3 comprises a plurality of flexible fins 22 extending substantially parallel to the translation direction.

In greater detail, the flexible fins 22, extending substantially parallel to the translation direction, are foldable around axes transversal to the translation direction mentioned above, so that, in expanded configuration, the aforementioned folded flexible fins 22 increase the size, on a plane transversal to the translation direction, of the locking portion 21, therefore enabling the latter to interfere with the first lateral surface 20.

Advantageously, a containment volume 24, which is at least partially internally delimited by a second lateral surface 26 is obtained in the locking portion 21.

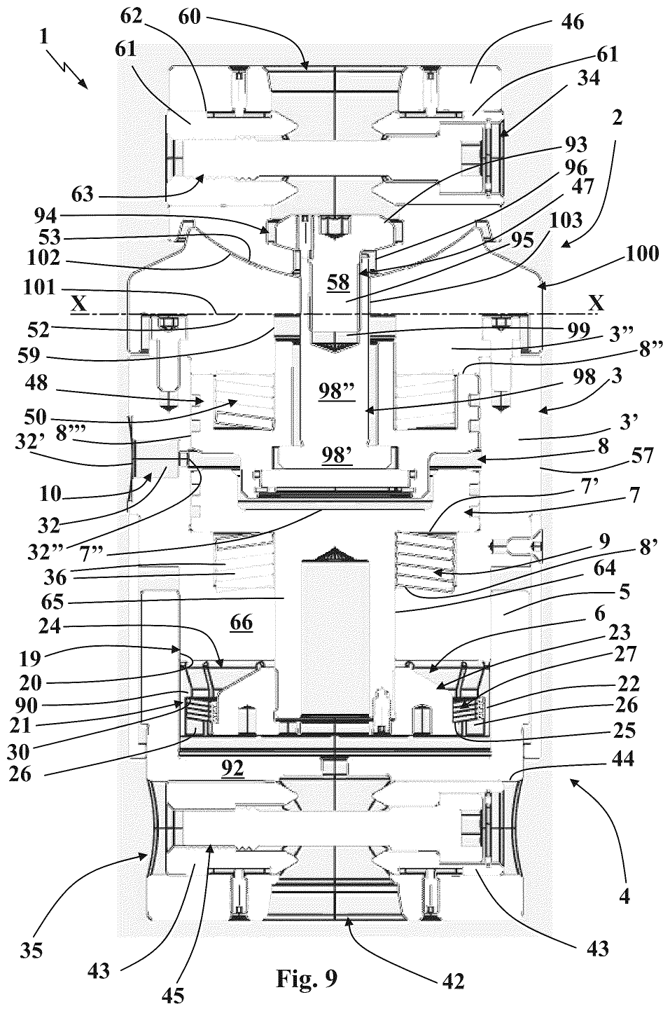

As observable in the attached FIG. 9, the containment volume 24 mentioned above is preferably delimited by the flexible fins 22, on which the second lateral surface 26 extends.

Furthermore, the first locking system 6 advantageously comprises a pusher body 23, which is slidably inserted into the containment volume 24, it is integrally joined at least in translation with the first actuation piston 7 and it comprises a thrust surface 25 adapted to interfere, directly or indirectly, with the second lateral surface 26 in order to push said locking portion 21 in the expanded configuration when the first actuation piston 7 is in the first actuation position.

In greater detail, in order to allow the pusher body 23 to be integrally joined at least in translation to the first actuation piston 7, the first connection body 3 is provided with at least one first communication opening 64 placed in communication with the first guide chamber 8 and the containment volume 24. Furthermore, the first actuation piston 7 and the pusher body 23 are mechanically connected to each other through the first communication opening 64 mentioned above.

In particular, the first actuation piston 7 comprises a connection barrel 65 arranged to traverse the first communication opening 64, at least partly extending in the containment volume 24 and fixed (for example by screwing, by shape-interlocking or the like) to the pusher body 23.

According to a variant embodiment, the second lateral surface 26 is tapered and the thrust surface 25 of the thrust surface 23 is shaped so that, when the first actuation piston 7 is in the first actuation position, it interferes with the second lateral surface 26 to carry the locking portion 21 in expanded configuration, and that, when the first actuation piston 7 is in the second actuation position, it does not interfere with the second lateral surface 26 to leave the locking portion 21 in the undeformed configuration.

Otherwise, according to the embodiments shown in the attached figures, the first locking system 6 advantageously comprises a second elastic member 27, which is arranged in said containment volume 24, it is arranged counter-faced to the second lateral surface 26, and it is susceptible to interfere, directly or indirectly, with the thrust surface 25 of the pusher body 23.

In greater detail, such second elastic member 27 can be actuated by the pusher body 23 mentioned above between a release configuration and a compression configuration.

In particular, when the first actuation piston 7 is in the second actuation position there occurs the release configuration, in which the second elastic member 27 is provided with a first radial overall dimension and with a first axial overall dimension so as not to interfere with the second lateral surface 26.

Furthermore, in particular, when the first actuation piston 7 is in the first actuation position there occurs the compression configuration, in which the second elastic member 27 is provided with a second radial overall dimension greater than the first radial overall dimension and with a second axial overall dimension smaller than the first axial overall dimension so as to interfere with the second lateral surface 26 and push the locking portion 21 in the expanded configuration.

Therefore, according to the shown embodiments, when the first actuation piston 7 is in the first actuation position, the thrust surface 25 of the pusher body 23, preferably, does not directly interfere with the second lateral surface 26, but it interferes with the second lateral surface 26 mentioned above through the second elastic member 27.

Advantageously, the second elastic member 27 comprises at least one second belleville washer 33 and, preferably, comprise a plurality of belleville washers 33 arranged on each other.

In greater detail, the at least one second belleville washer 33 extends with annular shape around an extension axis thereof substantially parallel to the translation direction and delimits a central opening 28 traversed by the pusher body 23.

Furthermore, such at least one second belleville washer 33 is advantageously provided with a larger base 29 thereof, which is in contact with the second lateral surface 26 and is arranged, directly or indirectly, resting against an abutment surface 30 extending in the containment volume 24 transversely to the second lateral surface 26.

In addition, the at least one second belleville washer 33 mentioned above is advantageously provided with a smaller base 31, which is opposite to the larger base 29 and it is susceptible to receive, directly or indirectly, against itself the thrust surface 25 of the pusher body 23 in order to be actuated between the compression configuration and the release configuration.

In particular, should there be provided for multiple second belleville washers 33, only one of them is provided with the larger base 29 thereof arranged resting directly against the abutment surface 30 and only one of them is provided with the smaller base 31 thereof susceptible to receive the thrust surface 25 directly against itself.

Advantageously, the first connection body 3 is provided with a partitioning wall 66 interposed between the first guide chamber 8 and the containment volume 24, on the partitioning wall 66 there being preferably obtained the first communication opening 64.

Advantageously, the first elastic member 9 is provided to force the first actuation piston 7 in the first actuation position and the first actuator 10 is provided to move the first actuation piston 7 in the second actuation position making the first elastic member 9 yield elastically.

Preferably, the first elastic member 9 is interposed between the first actuation piston 7 and the partitioning wall 66. In addition, the second elastic member 27 is interposed between the abutment surface 30 and the thrust surface 25 of the pusher body 23, the thrust surface 25 in particular being faced towards the partitioning wall 66.

According to a variant embodiment not shown, the abutment surface 30 may directly extend on the partitioning wall 66 on the side of the containment volume 24.

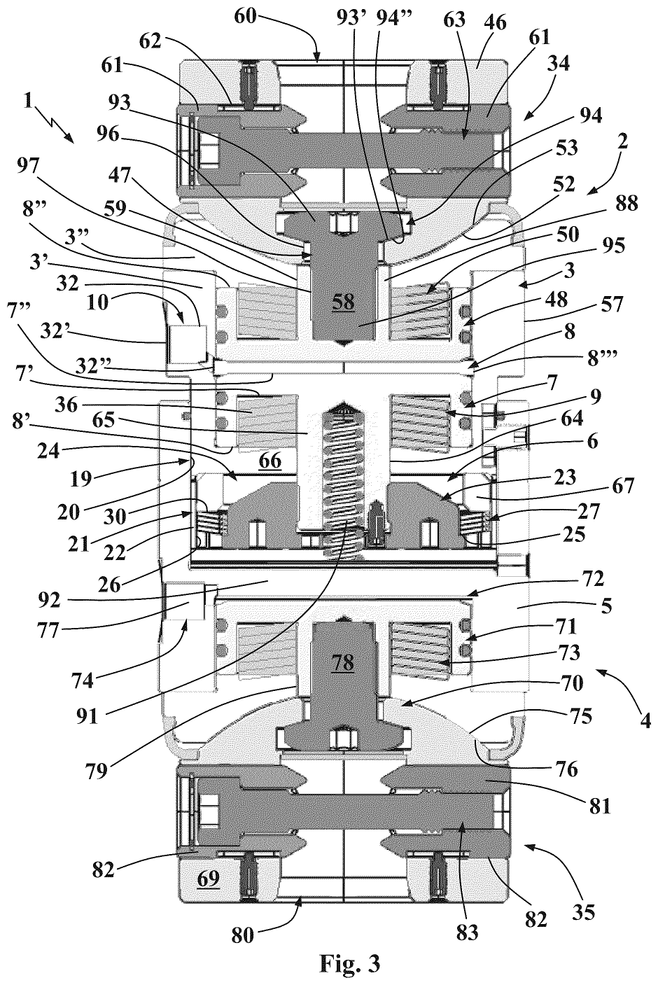

Otherwise, according to the first embodiment, as shown in FIG. 3, the abutment surface 30 is advantageously defined by a support ring 67 arranged against the partitioning wall 66 and in particular housed in the containment volume 24.

Still otherwise, according to the second embodiment, each flexible fin 22 is made of a single body with a retention step 90. In addition, on each of such retention steps 90 there extends a part of the abutment surface 30 facing towards the opposite direction with respect to the partitioning wall 66.

In particular, the first face 7′ of the first actuation piston 7 is faced toward the partitioning wall 66 and the first end surface 8′ of the first guide chamber 8 extends on the partitioning wall 66 mentioned above, with the first elastic member 9 which is preferably interposed between the aforementioned first end surface 8′ and the first face 7′ of the first actuation piston 7.

According to the two depicted embodiments, in order to ensure that the first elastic member 9 can advantageously maintain the first actuation piston 7 in the first actuation position, the second elastic member 27 is provided with a lower stiffness with respect to that of the first elastic member 9.

Preferably, as shown in FIG. 6, in order to confer low stiffness to the second elastic member 27 (in particular lower stiffness with respect to that of the first elastic member 9), the at least one second belleville washer 33 is provided with a plurality of weakening grooves 68, which in particular extend one starting from the lower base 31 and one starting from the larger base 29 in an alternating fashion throughout the circumferential extension of the second belleville washer 33 around the extension axis.

In this manner, the first elastic member 9 tends to maintain the first actuation piston 7 moved away from the partitioning wall 66, so that the pusher body 23 is maintained approached to the abutment surface 30 and maintains, through the thrust surface 25 thereof, the second elastic member 27 in compression configuration, therefore ensuring that the latter take the second radial overall dimension and therefore interfere with the second lateral surface 26 carrying the locking portion 21 in expanded configuration.

Furthermore, the device 1 in question may comprise an auxiliary elastic member 91, which is arranged in the guide seat 19 and it is provided to exert on the pusher body 23 or on the connection barrel 65 of the first actuation piston 7 (should the pusher body 23 be for example traversed by a through hole that is screw or coupling-engaged by the connection barrel 65) an elastic force having the same direction as the one exerted by the first elastic member 9.

In this manner, together with the first elastic member 9, the auxiliary elastic member 91 participates in overcoming the elastic force exerted by the second elastic member 27, so that the first elastic member 9 safely maintain the first actuation piston 7 in the first actuation position, which in turn maintains, through the pusher body 23, the second elastic member 27 in expanded configuration so as to block the mutual sliding between the first and the second connection body 3, 5.

In particular, the second connection body 5 comprises a bottom wall 92, which is transversal to the lateral wall 20, is arranged to delimit the guide seat 19 together with the lateral wall 20 mentioned above and it is faced towards the partitioning wall 66. Furthermore, the auxiliary elastic member 91 is interposed between such bottom wall 92 and the pusher body 23 or the connection barrel 65.

According to a variant not shown of the clamping device 1 according to the invention, both the first and the second connection body 3, 5 are advantageously intended to be removably directly fixed, respectively by means of the first and of the second coupling means 34, 35 (in particular threaded), one to the support base and the other to the semi-finished product or vice versa.

According to such variant embodiment not shown, the first coupling means 34 advantageously comprise at least one first tensioner, which is provided with a first shaped head which can be inserted into a first coupling seat obtained on the first connection body 3 and with a first threaded shank extending starting from the aforementioned first shaped head and intended to be screwed to the support base or to the semi-finished product, and two first jaws, which are slidably inserted into a first guide groove obtained on the first connection body 3 to intercept the first coupling seat and they can be switched, by means of a first screw-and-nut mechanism, between an engagement configuration, in which they are closed against the first shaped head housed in the first coupling seat, and a first release configuration, in which they are spaced apart from the first shaped head.

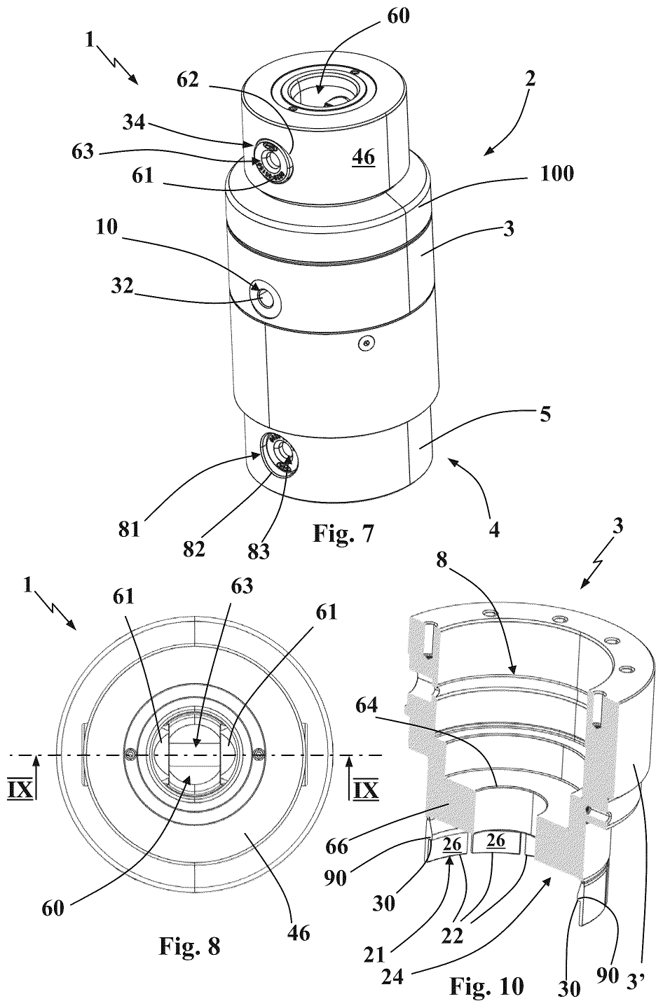

Furthermore, according to the variant embodiment mentioned above, as will be addressed again below with reference to the embodiment shown in the attached FIGS. 7 to 10, the second coupling means 35 advantageously comprise at least one second pulling element (not shown), which is provided with a second shaped head which can be inserted into a second coupling seat 42 obtained on the second connection body 5 and with a second threaded shank extending starting from the second shaped head mentioned above and intended to be screwed to the support base or to the semi-finished product, and two second jaws 43, which are slidably inserted into a second guide groove 44 obtained on the second connection body 5 to intercept the second coupling seat 42 and they can be switched, by means of a second screw-and-nut mechanism 45, between a second engagement configuration, in which they are closed against the second shaped head housed in the second coupling seat 42, and a second release configuration, in which they are spaced apart from the second shaped head.

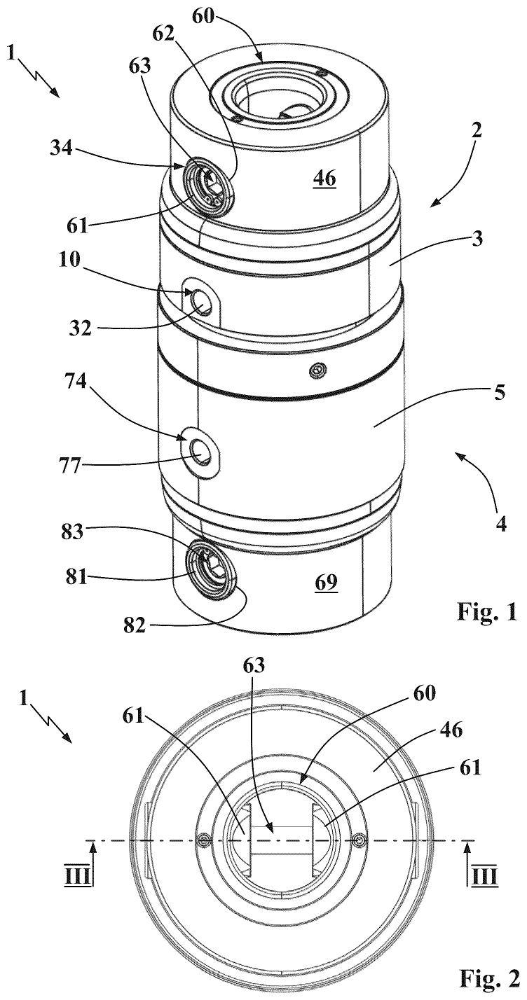

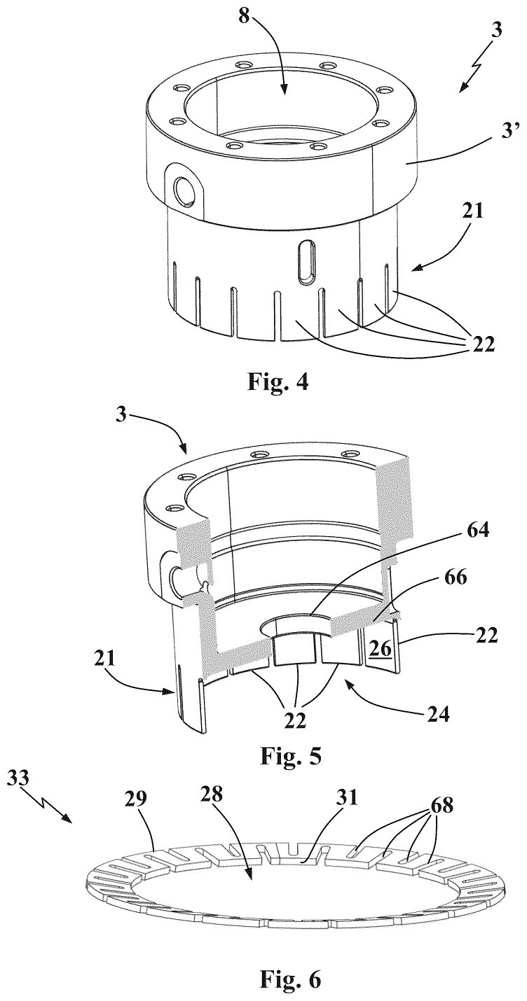

Both according to the first embodiment shown in the attached FIGS. 1 to 6 and according to the second embodiment shown in the attached FIGS. 7 to 10, the first clamping assembly 2 advantageously comprises a third connection body 46, which is rotatably connected to the first connection body 3 around at least one rotation axis in order to ensure that such first and third connection body 3, 46 are movable one with respect to the other in a plurality of second adjustment positions.

Furthermore, the first clamping assembly 2 advantageously comprises a second locking system 47, which is mechanically associated with the first and the third connection body 3, 46 and it can be switched between a second constraint condition, in which it locks the first and the third connection body 3, 46 in one of the second adjustment positions, and a second release condition, in which it frees the first and the third connection body 3, 46 to mutually rotate one with respect to the other.

Furthermore, such first clamping assembly 2, advantageously comprises a second actuation piston 48, which is slidably inserted into the first guide chamber 8 in order to translate between a third actuation position, in which it maintains said second locking system 47 in the second constraint condition, and a fourth actuation position, in which it maintains said second locking system 47 in the second release condition.

The first clamping assembly 2 mentioned above advantageously further comprises a third elastic member 50, which is inserted into the first guide chamber 8 and it is provided to force the second actuation piston 48 into one of the third actuation position and the fourth actuation position.

Similarly to the first elastic member 9, the third elastic member 50 preferably comprises at least one third belleville washer and, in particular, more than one third belleville washer arranged on each other.

Furthermore, the first actuator 10 (besides being provided to move the first actuation piston 7 making the first elastic member 9 yield elastically) is also advantageously provided to move the second actuation piston 48 in the other of the third and the fourth actuation position making the third elastic member 50 yield elastically.

In greater detail, the third connection body 46, the second locking system 47, the second actuation piston 48, the third elastic member 50 allow to increase, when the first locking system 6 is in the first release condition and the second locking system 47 is in the second release condition, the degrees of freedom of the clamping device 1 useful to compensate pulling and/or compression stresses induced by the processing operations to which the semi-finished product is subjected.

Furthermore, the provision of the second actuation piston 48 and of the third elastic member 50 in the same first guide chamber 8 in which there are arranged the first actuation piston 7 and the first elastic member 9 allows to increase through the third connection body 46 the degrees of freedom useful to compensate for the stresses induced by the processing operations maintaining the clamping device 1 in question as compact as possible, therefore avoiding the provision of further actuation means (distinct with respect to the first actuation means 10) and of a further guide chamber obtained in the first connection body 3 and adapted to contain the second actuation piston 48 and the third elastic member 50.

Without departing from the scope of protection of the present invention, according to further embodiments not shown, the first connection body 3 is provided with a further guide chamber, the second actuation piston 48 is slidably inserted into such further guide chamber to translate between the third actuation position and the fourth actuation position, the third elastic member 50 is housed in the further guide chamber mentioned above. Furthermore, there are provided for further actuation means (distinct with respect to the first actuation means 10) provided to move the second actuation piston 48 into the other of the third and fourth actuation position (other with respect to the one in which the second actuation piston 48 is forced by the third elastic member 50) making the third elastic member 50 yield elastically.

In particular, both in the first and in the second embodiment (wherein the second actuation piston 48 is slidably inserted into the first guide chamber 8), the first actuator 10 advantageously comprises a first conveyance duct 32 placed in fluid connection with the first guide chamber 8 and provided to convey a pressurised fluid both against the first actuation piston 7 to make the first elastic member 9 yield elastically and push the first actuation piston 7 into the other of the first and of the second actuation piston (that is, in other words, other with respect to the position in which the first actuation piston 7 is forced by the first elastic member 9), and against the second actuation piston 48 to make the third elastic member 50 yield elastically and push the second actuation piston 48 into the other of the third and fourth actuation position (that is, in other words, other with respect to the position in which the second actuation piston 48 is forced by the third elastic member 50).

In greater detail, in such case, the first conveyance duct 32 mentioned above extends between a receipt opening 32′, which is arranged on an outer lateral surface 57 of the first connection body 3 (in particular an outer lateral surface 57 of the first component 3′ of the first connection body 3), and a conveyance opening 32″, which is placed in fluid connection with the first guide chamber 8, in particular obtained on the inner lateral surface 8′″ in a position interposed between the first and the second actuation piston 7, 48. In this manner, by introducing into the first conveyance duct 32 a pressurised fluid, the latter is capable of simultaneously moving both the first and the second actuation piston 7, 48.

Advantageously, the third elastic member 50 is provided to force the second actuation piston 48 in the third actuation position and the first actuator 10 is provided to move the second actuation piston 48 in the fourth actuation position making the third elastic member 50 yield elastically.

In this manner, the third elastic member 50 ensures that the second locking system 47 is automatically in the second constraint condition so as to precisely maintain the first and the third connection body 3, 46 in a desired second adjustment position throughout the processing operations to which the semi-finished product is subjected and ensure that it is sufficient to briefly act on the first actuator 10 at the end of the processing operations mentioned above so as to compensate for possible pulling and/or compression stresses which developed during the processing operations.

Advantageously, the first connection body 3 is provided with a first sliding surface 52 and the third connection body 46 is provided with a second sliding surface 53, which is in particular faced towards the first sliding surface 52.

In greater detail, one of the first and the second sliding surface 52, 53 is convex-shaped, so as to allow a rotation of the third connection body 46 with respect to the first connection body 3 between various adjustment positions.

Furthermore, the second locking system 47 advantageously comprises a first pulling element 58, which is mechanically associated with the third connection body 46 and is integrally joined at least in translation with second actuation piston 48 to pull, with the second actuation piston 48 in the third actuation position, the first sliding surface 52 by pressure against the second sliding surface 53, directly or indirectly (in greater detail, the expression “indirectly” shall be used to indicate that the first and the third connection body 3, 46 may have one or more other components interposed between them).

In this manner, when the actuation piston 48 is in the third actuation position, the third connection body 46 and the first connection body 3 are pulled one towards the other by the first pulling element 58 so that the exerted pressure generates friction at the first sliding surface 52 and the second sliding surface 53 (the friction is generated both in the case where the first and the second sliding surface 52, 53 are directly in contact, and in the case where there are one or more other components interposed between them) which locks the first and the third connection body 3, 46 in a desired second adjustment position.

In particular, the first pulling element 58 of the second locking system 47 is mechanically associated with the third connection body 46 so as to be able to pull it towards the first connection body 3 when the second actuation piston 48 is in the third actuation position and it is mechanically associated with the first connection body 3 given that it is integrally joined in translation with the second actuation piston 48 inserted into the first guide chamber 8 of the first connection body 3.

In order to allow the first pulling element 58 to be integrally joined at least in translation with the second actuation piston 48 slidably inserted into the first guide chamber 8, the first connection body 3 is preferably provided with a second communication opening 59 (in particular obtained on the second component 3″) extending starting from the first sliding surface 52, communicating with the first guide chamber 8 and traversed by such first pulling element 58, which is mechanically connected to the second actuation piston 48 so as to be integrally joined at least in translation with it.

Furthermore, the first pulling element 58 of the second locking system 47 is preferably provided with a widened head 93, which is housed with clearance in a containment chamber 94 obtained in the third connection body 46, and with a shank 95 extending starting from the widened head 93, fixed to the second actuation piston 48 (directly fixed or fixed using other components) and arranged to traverse the second communication opening 59 and a third communication opening 96, which is obtained on the third connection body 46 substantially at the second communication opening 59, it communicates with the containment chamber 94 and it is smaller in size with respect to the widened head 93 to prevent it from exiting from the containment chamber 94.

In this manner, when the second actuation piston 48 is in the third actuation position to switch the second locking system 47 in the second release condition, the second actuation piston 48 mentioned above drives, using the shank 95, the widened head 93 of the first pulling element 58 towards the first connection body 3, so that the widened head mentioned above 93 pulls the second sliding surface 53 of the third connection body 46 by pressure against the first sliding surface 52, directly or indirectly with one or more other components interposed.

In particular, the widened head 93 is provided with a locking surface 93′ rounded and facing towards the first connection body 3 and the containment body 94 is provided with an abutment surface 94′ facing towards and substantially counter-shaped with respect to the locking surface 93′ mentioned above.

Therefore, in this manner, when the second actuation piston 47 is in the fourth actuation position, the locking surface 93′ and the abutment surface 94′ are spaced apart to allow the first and the third connection body 3, 46 to rotate between the second adjustment positions and, when the second actuation piston 48 is in the first actuation position, the locking surface 93′ abuts against the abutment surface 94′ without the pressure exerted by the locking surface 93′ on the abutment surface 94′ risking to change the first adjustment position established between the first and the third connection body 3, 46 (given that the locking surface 93′ is rounded). According to the first embodiment shown in the attached FIGS. 1 to 6, the first sliding surface 52 and the second sliding surface 53 advantageously slide on each other with the first connection body 3 and the third connection body 46 which rotate around at least one rotation axis.

In greater detail, the first pulling element 58 is integrally joined in translation with the second actuation piston 48 to pull in pressurised abutment the first sliding surface 52 against the second sliding surface 53 with the second actuation piston 48 in the third actuation position.

Preferably, in order to make the first pulling element 58 integrally joined in translation with the second actuation piston 48, the shank 95 of the first pulling element 58 is threaded and the second actuation piston 48 is provided with a corresponding first threaded seat 97 engaged by the shank 95.

In particular, according to such first embodiment, the first pulling element 58 is capable of pulling in pressure abutment the first and the second sliding surface 52, 53 because they are directly in contact with each other, given that the first and the second sliding surface 52, 53 slide on each other with the first connection body 3 and the third connection body 46 which rotate around the at least one rotation axis.

Preferably, one of the first sliding surface 52 and the second sliding surface 53 is concave with substantially spherical cap shape and the other of the first sliding surface 52 and the second sliding surface 53 is convex with substantially spherical cap shape, so that the first connection body 3 and the third connection body 46 are rotatably connected to each other around three mutually orthogonal rotation axes.

According to the second embodiment shown in the attached FIGS. 7 to 10, the first clamping assembly 2 advantageously comprises a fourth connection body 100, which is interposed between the first connection body 3 and the third connection body 46.

Such fourth connection body 100 is advantageously traversed by the first pulling element 58 and it is provided with its own third sliding surface 101 in contact with the first sliding surface 52 and with its own fourth sliding surface 102 in contact with the second sliding surface 53.

Preferably, such fourth connection body 100 is provided with a fourth communication opening 103 extending between the third and the fourth sliding surface 101, 102 and traversed by the first pulling element 58, in particular by the shank 95 of the latter.

In greater detail, the fourth connection body 100 mentioned above is slidably associated with the first connection body 3 along an adjustment plane X transversal (in particular orthogonal) to the translation direction (that is the direction along which the first and the second connection body 3, 5 may slide one with respect to the other) in a plurality of third adjustment positions. Furthermore, it carries rotatably mounted thereon the third connection body 46 around at least one rotation axis in order to ensure that the first connection body 3 and the third connection body 46 are movable one with respect to the other in the plurality of the second adjustment positions.

In this manner, the second adjustment positions in the second embodiment may be distinguished from each other not only due to the different orientation of the third connection body 46 with respect to the first connection body 3, but also due to a different point on the adjustment plane X in which the third connection body 46 is placed with respect to the first connection body 3, given that the third connection body 46 mentioned above may rotate with respect to the fourth connection body 100 on which it is mounted and the fourth connection body 100 may translate in a plurality of distinct third adjustment positions on the adjustment plane X with respect to the first connection body 3.

Furthermore, the first pulling element 58 is preferably integrally joined in translation with the second actuation piston 48 to pull, with the second actuation piston 48 in the third actuation position, the second sliding surface 53 in pressurised abutment against the fourth sliding surface 102 and the third sliding surface 101 in pressurised abutment against the first sliding surface 52.

In particular, the first sliding surface 52 and the third sliding surface 101 are planar and coincident with the adjustment plane X.

Furthermore, preferably, one of the second sliding surface 53 and the fourth sliding surface 102 is concave with substantially spherical cap shape and the other of the second sliding surface 53 and the fourth sliding surface 102 is convex with substantially spherical cap shape, so that the fourth connection body 100 and the third connection body 46 are rotatably connected to each other around three mutually orthogonal rotation axes.

Preferably, the first pulling element 58 is fixed to a slider 98 (for example by screwing the shank 95 in a specific second threaded seat 99 obtained on the slider 98) slidably associated with the second actuation piston 48 on a movement plane parallel to the adjustment plane X.

In particular, such slider 98 is provided with a flattened base 98′ slidably inserted into a translation seat obtained in the second actuation piston 48 and with a barrel 98″, which extends protruding from the flattened base 98′, it is provided with the second threaded seat 99 engaged by the shank 95 of the first pulling element 58 and substantially fittingly traverses the fourth communication opening 103 of the fourth connection body 100.

In this manner, when the fourth connection body 100 translates on the adjustment plane X, the barrel of the slider 98 which substantially fittingly occupies the fourth communication opening 103 in turn translates thanks to its own flattened base inserted into the translation seat of the second actuation piston 48.

According to a variant embodiment not shown, there may be provided for the fourth connection body 100 without the third connection body 46 being present. In this case, in order to lock the fourth connection body 100 with respect to the first connection body 3 or to release the fourth connection body 100 to translate with two degrees of freedom on the adjustment plane X with respect to the first connection body 3, there is provided for substantially the same second locking system 47 of the second embodiment shown in the attached FIGS. 7 to 10 (obviously resized so as to be able to act on the fourth connection body 100 without the third connection body 46 being present).

In this case, the first clamping assembly 2 advantageously comprises a fourth connection body 100, which is slidably associated with the first connection body 3 with two degrees of freedom on an adjustment plane X transversal (in particular orthogonal) to the translation direction (that is the direction along which the first and the second connection body 3, 5 can slide one with respect to the other) in a plurality of third adjustment positions. Furthermore, the second locking system 47 is mechanically associated with the first and with the fourth connection body 3, 100 and it can be switched between a second constraint condition, in which it locks the first and the fourth connection body 3, 100 in one of the third adjustment positions, and a second release condition, in which it frees the first and the fourth connection body 3, 100 to translate one with respect to the other with two degrees of freedom on the adjustment plane X.

Furthermore, as mentioned above, there is advantageously provided for a second actuation piston 48, which is slidably inserted into the first guide chamber 8 in order to translate between a third actuation position, in which it maintains said second locking system 47 in the second constraint condition, and a fourth actuation position, in which it maintains said second locking system 47 in the second release condition.

As described above, the first clamping assembly 2 advantageously further comprises third elastic member 50, which is inserted into the first guide chamber 8 and it is provided to force the second actuation piston 48 into one of the third actuation position and the fourth actuation position.

Furthermore, the first actuator 10 (besides being provided to move the first actuation piston 7 making the first elastic member 9 yield elastically) is also advantageously provided to move the second actuation piston 48 in the other of the third and the fourth actuation position making the third elastic member 50 yield elastically.

Preferably, according to such embodiment without third connection body 46 and provided with the fourth connection body 100, the fourth connection body 100 mentioned above is provided with its own third sliding surface 101 in contact with the first sliding surface 52 of the first connection body 3 (and instead there is not provided for the fourth sliding surface 102 given that there is no third connection body 46).

In this case, the second locking system 47 advantageously comprises a first pulling element 58, which (is not mechanically associated with the third connection body 46 given that the latter is absent, but) is mechanically associated with the fourth connection body 100 and it is integrally joined at least in translation with the second actuation piston 48 to pull, with the second actuation piston 48 in the third actuation position, the first sliding surface 52 in pressurised abutment against the third sliding surface 101.

In greater detail, according to such embodiment provided with the fourth connection body 100 and without the third connection body 46, the fourth connection body 100 is provided with a retaining surface, which is faced in the opposite direction with respect to the third sliding surface 101, and with a fourth communication opening 103, which extends between the retaining surface and the third sliding surface 100. Furthermore, the first pulling element 58 is provided with a widened head 93, which is arranged adjacently to the retaining surface (for example, such widened head 93 is contained in a corresponding containment chamber obtained in the fourth connection body 100 and partially delimited by the retaining surface mentioned above), and with a shank 95 extending starting from the widened head 93, mechanically connected to the second actuation piston 48 and arranged to traverse the second communication opening 59 and the fourth communication opening 103 mentioned above.

In this manner, when the second actuation piston 48 is in the third actuation position, the widened head 93 is driven by the shank 95 towards the first connection body 3 and it presses against the retaining surface to push the third sliding surface 101 of the fourth connection body 100 abutting against the first sliding surface 52 of the first connection body 3, therefore locking the first and the fourth connection body 3, 100 in a third adjustment position due to the friction which occurs at the first and third sliding surface 52, 101.

In particular, also according to the aforementioned embodiment not shown, the first sliding surface 52 and the third sliding surface 101 are planar and coincident with the adjustment plane X.

Preferably, also should there not be provided for the third connection body 46, the first pulling element 58 is fixed to a slider 98 (for example by screwing the shank 95 in a specific second threaded seat 99 obtained on the slider 98) slidably associated with the second actuation piston 48 on a movement plane parallel to the adjustment plane X.

In particular, such slider 98 is provided with a flattened base 98′ slidably inserted into a translation seat obtained in the second actuation piston 48 and with a barrel 98″, which extends protruding from the flattened base 98′, it is provided with the second threaded seat 99 engaged by the shank 95 of the first pulling element 58 and substantially fittingly traverses the fourth communication opening 103 of the fourth connection body 100.

In this manner, when the second actuation piston 48 is in the fourth actuation position, the fourth connection body 100 and the first pulling element 58 fixed to the slider 98 may slide together on the adjustment plane X with two degrees of freedom, given that the barrel 98″ of the slider 98 substantially fittingly traverses the fourth communication opening 103 and the flattened base 98′ is slidably inserted into the translation seat of the second actuation piston 48. Otherwise, the shank 95 of the first pulling element 58 may be directly fixed to the second actuation piston 48 (for example by screwing the shank 95 in a specific threaded seat obtained on the second actuation piston 48) and traverse with clearance the fourth communication opening 103 of the fourth connection body 100 (in this case, the maximum translation possible on the adjustment plane X that can be carried out by the fourth connection body 100 with respect to the first connection body 3 depends on the size difference between the diameter of the shank 95 and of the fourth communication opening 103).

According to the embodiment not shown provided with the fourth connection body 100 and without the third connection body 46, the first coupling means 34 advantageously comprise at least one fifth pulling element (not shown), which is provided with a fifth shaped head which can be inserted into a fifth coupling seat obtained on the fourth connection body 100 and with a fifth threaded shank extending starting from the fifth shaped head mentioned above and intended to be screwed to the support base or to the semi-finished product, and two fifth jaws, which are slidably inserted into a fifth guide groove obtained on the fourth connection body 100 to intercept the fifth coupling seat and they can be switched, by means of a fifth screw-and-nut mechanism, between a fifth engagement configuration, in which they are closed against the fifth shaped head housed in the fifth coupling seat, and a fifth release configuration, in which they are spaced apart from the fifth shaped head.

Advantageously, according to the first and the second embodiment shown, the first coupling means 34 advantageously comprise at least one third pulling element (not shown), which is provided with a third shaped head which can be inserted into a third coupling seat 60 obtained on the third connection body 46 and with a third threaded shank extending starting from the third shaped head mentioned above intended to be screwed to the support base or to the semi-finished product, and two third jaws 61, which are slidably inserted into a third guide groove 62 obtained on the third connection body 46 to intercept the third coupling seat 60 and they can be switched, by means of a third screw-and-nut mechanism 63, between a third engagement configuration, in which they are closed against the third shaped head housed in the third coupling seat 60, and a third release configuration, in which they are spaced apart from the third shaped head.

Furthermore, as mentioned above, the second embodiment shown provides for that the second coupling means 35 comprise a second pulling element with the second shaped head thereof inserted into the second coupling means 42 obtained on the second coupling seat 5, two second jaws 43 and a second screw-and-nut mechanism 45. Therefore, the second clamping assembly 2 can be removably fixed to the semi-finished product or to the support base directly at the second connection body 5.

Otherwise, as provided for in the first embodiment, the second clamping assembly 2 may comprise further connection bodies.

As a matter of fact, according to the first embodiment mentioned above, the second clamping assembly 4 advantageously comprises a fifth connection body 69, which is rotatably connected to the second connection body 5 around at least one rotation axis so as to ensure that such second and fifth connection body 5, 69 are movable one with respect to the other in a plurality of fourth adjustment positions.

Furthermore, the second clamping assembly 4 advantageously comprises a third locking system 70, which is mechanically associated with the second and the fifth connection body 5, 69 and it can be switched between a third constraint condition, in which it blocks the second and the fifth connection body 5, 69 in one of the fourth adjustment positions, and a third release condition, in which it releases the second and the fifth connection body 5, 69 to mutually rotate one with respect to the other.

Furthermore, such second clamping assembly 4 advantageously comprises a third actuation piston 71, which is slidably inserted into a second guide chamber 72 obtained on one of the second and the fifth connection body 5, 69 in order to translate between a fifth actuation position, in which it maintains the third locking system 70 in the third constraint condition, and a sixth actuation position, in which it maintains the third locking system 70 in the third release condition.

The second clamping assembly 4 mentioned above advantageously further comprises a fourth elastic member 73, which is inserted into the second guide chamber 72 and it is provided to force the third actuation piston 71 in one of the fifth and the sixth actuation position, and a second actuator 74, which is provided to move the third actuation piston 71 into the other of the fifth and the sixth actuation position making the fourth elastic member 73 yield elastically. Advantageously, the fourth elastic member 73 is provided to force the third actuation piston 71 into the fifth actuation position and the second actuator 74 is provided to move the third actuation piston 71 in the sixth actuation position making the fourth elastic member 73 yield elastically.

In this manner, the fourth elastic member 73 ensure that the third locking system 70 is automatically in the third constraint condition so as to precisely maintain the second and the fifth connection body 5, 69 in a desired fourth adjustment position throughout the processing operations to which the semi-finished product is subjected and which is sufficient to briefly act on the second actuator 74 at the end of the processing operations mentioned above so as to compensate for possible pulling and/or compression stresses which developed during the processing operations.

Preferably, in order to allow maximum freedom of mutual movement between the second and the third connection body 5, 69, the second and the fifth connection body 5, 69 are rotatably connected around three mutually orthogonal rotation axes to move one with respect to the other in the plurality of fourth adjustment positions.

Advantageously, the second connection body 5 is provided with a fifth sliding surface 75 and the fifth connection body 69 is provided with a sixth sliding surface 76, the fifth and sixth sliding surface 75, 76 slide on each other with the second and the fifth connection body 5, 69 which rotate around the at least one rotation axis.

Preferably, one of the fifth and the sixth sliding surface 75, 76 is concave with substantially spherical cap shape and the other of the fifth and the sixth sliding surface 75, 76 is convex with substantially spherical cap shape, so that the second and the fifth connection body 5, 69 are advantageously rotatably connected to each other around three mutually orthogonal rotation axes.

Advantageously, the second actuator 74 comprises at least one second conveyance duct 77 obtained on the one between the second and the fifth connection body 5, 69 on which there is obtained the second guide chamber 72, placed in fluid communication with the second guide chamber 72 and provided to convey a pressurised fluid against the third actuation piston 71 so as to make the fourth elastic member 73 yield elastically and push the third actuation piston 71 in the other of the fifth actuation position and the sixth actuation position.

Preferably, the second guide chamber 72 for the third actuation piston 71 is obtained on the second connection body 5.

As a result, the second conveyance duct 77 is in turn preferably obtained on the second connection body 5.

Furthermore, the third locking system 70 advantageously comprises a third pulling element 78, which is mechanically associated with the one between the second and the fifth connection body 5, 69 on which there is not obtained the second guide chamber 72 and it is integrally joined at least in translation with the third actuation piston 71 to pull in pressurised abutment the fifth sliding surface 75 against the sixth sliding surface 76 with the third actuation piston 71 in the fifth actuation position.

In particular, in order to allow the second pulling element 78 to be integrally joined at least in translation with the third actuation piston 71 slidably inserted into the second guide chamber 72, the one between the second and the fifth connection body 5, 69 on which there is obtained the second guide chamber 72 is provided with a fifth communication opening 79 extending starting from the corresponding fifth or sixth sliding surface 75, 76, communicating with the second guide chamber 72 and traversed by such second pulling element 78, which is mechanically connected to the third actuation piston 71 so as to be integrally joined at least in translation therewith.

As shown in FIG. 3, given that the second guide chamber 72 is advantageously obtained on the second connection body 5, the second pulling element 78 is mechanically associated with the fifth connection body 69 and the fifth communication opening 79 is obtained on the second connection body 5 mentioned above.

Furthermore, according to the first embodiment mentioned above, the second coupling means 35 advantageously comprise at least one fourth pulling element (not shown), which is provided with a fourth shaped head which can be inserted into a fourth coupling seat 80 obtained on the fifth connection body 69 and with a fourth threaded shank extending starting from the fourth shaped head mentioned above and intended to be screwed to the support base or to the semi-finished product, and two fourth jaws 81, which are slidably inserted into a fourth guide groove 82 obtained on the fifth connection body 69 to intercept the fourth coupling seat 80 and they can be switched, by means of a fourth screw-and-nut mechanism 83, between a fourth engagement configuration, in which they are closed against the fourth shaped head housed in the fourth coupling seat 80, and a fourth release configuration, in which they are spaced apart from the fourth shaped head.

In this manner, in the first embodiment, the fifth connection body 69 can be directly removably fixed to the support base or to the semi-finished product using second coupling means 35.

In greater detail, the first embodiment of the clamping device 1 has great versatility given that it can allow to compensate for:
a change in the distance between the semi-finished product and the support base following a processing operation, through the first and second connection body 3, 5 which are slidably associated with each other; and also
a significant change in the inclination between the semi-finished product and the support base, through the third and fifth connection body 46, 69 rotatably connected around the at least one rotation axis respectively to the first and to the second connection body 3, 5.

Furthermore, also the second embodiment of the clamping device 1 has great versatility given that it can allow to compensate for:
a change in the distance between the semi-finished product and the support base following a processing operation, similarly to the first embodiment, through the first and second connection body 3, 5 which are slidably associated with each other;
a change in the inclination between the semi-finished product and the support base, through the third connection body 46 rotatably connected around the at least one rotation axis to the first connection body 3; and also
a misalignment in which the clamping device 1 is removably fixed to the support base and to the semi-finished product through the fourth connection body 100 which is slidably associated with the first connection body 3 on the adjustment plane X.

Therefore, the invention thus conceived attains the pre-established objects.

The contents of the Italian patent application number 102023000019062, from which this application claims priority, are incorporated herein by reference.

1. A clamping device for holding a semifinished product in position with respect to a support base, which comprises:
at least one first clamping assembly (2), which is intended to be removably fixed to one of said support base and said semi-finished product and it comprises at least one first connection body (3);
at least one second clamping assembly (4), which is intended to be removably fixed to the other of said semi-finished product and said support base and it comprises at least one second connection body (5); said first and second connection body (3, 5) being mechanically engaged to mutually move one with respect to the other between a plurality of first adjustment positions; said first and second connection body (3, 5) being slidably associated along a translation direction to move one with respect to the other in said plurality of said first adjustment positions;
a first locking system (6), which is mechanically associated with said first and with said second connection body (3, 5) and they can be switched between a first constraint condition, in which it locks said first and second connection body (3, 5) into one of said first adjustment positions, and a first release condition, in which it frees said first and second connection body (3, 5) to mutually move one with respect to the other;
a first actuation piston (7), which is slidably inserted into a first guide chamber (8) obtained on said first connection body (3) in order to translate between a first actuation position, in which it maintains said first locking system (6) in said first constraint condition, and a second actuation position, in which it maintains said first locking system (6) in said first release condition;
a first elastic member (9), which is inserted into said first guide chamber (8) and it is provided to force said first actuation piston (7) into one of said first actuation position and said second actuation position;
a first actuator (10), which is provided to move said first actuation piston (7) into the other of said first and second actuation position, making said first elastic member (9) yield elastically;
wherein said second connection body (5) is provided with a guide seat (19) at least partially internally delimited by a first lateral surface (20) and said first connection body (3) is at least partially inserted into said guide seat (19) slidably along said translation direction;
said first connection body (3) being provided with a locking portion (21) contained in said guide seat (19) and deformable between an expanded configuration, in which it exerts a pressure against said first lateral surface (20) to prevent said first connection body (3) from sliding into said guide seat (19), and an undeformed configuration, in which it does not exert pressure against said first lateral surface (20) allowing said first connection body (3) to slide in said guide seat (19);
said first locking system (6) being provided to maintain the locking portion (21) of said first connection body (3) in said expanded configuration when it is in said first constraint condition and being provided to maintain said locking portion (21) in said undeformed configuration when it is in said first release condition.

2. The clamping device according to claim 1, wherein said first elastic member (9) is provided to force said first actuation piston (7) in said first actuation position;
said first actuator (10), being provided to move said first actuation piston (7) in said second actuation position, making said first elastic member (9) yield elastically.

3. The clamping device according to claim 1, wherein said first actuator (10) comprises at least one first conveyance duct (32) obtained on said first connection body (3), placed in fluid communication with said first guide chamber (8) and provided to convey a pressurized fluid against said first actuation piston (7) in order to make said first elastic member (9) yield elastically and push said first actuation piston (7) into the other of said first actuation position and said second actuation position.

4. The clamping device according to claim 1, wherein the locking portion (21) of said first connection body (3) comprises a plurality of flexible fins (22) extending substantially parallel to said translation direction.

5. The clamping device according to claim 1, wherein in said locking portion (21) there is obtained a containment volume (24), which is at least partially internally delimited by a second lateral surface (26);
said first locking system (6) comprising a pusher body (23), which is slidably inserted into said containment volume (24), it is integrally joined at least in translation with said first actuation piston (7) and it comprises a thrust surface (25) adapted to interfere, directly or indirectly, with said second lateral surface (26) in order to push said locking portion (21) in said expanded configuration when said first actuation piston (7) is in said first actuation position.

6. The clamping device according to claim 5, wherein said first locking system (6) comprises a second elastic member (27), which is arranged in said containment volume (24), is arranged counter-faced to said second lateral surface (26), is susceptible to interfere, directly or indirectly, with the thrust surface (25) of said pusher body (23) and can be actuated by said pusher body (23) between:
a release configuration, when said first actuation piston (7) is in said second actuation position, in which said second elastic member (27) is provided with a first radial overall dimension and with a first axial overall dimension so as not to interfere with said second lateral surface (26), and
a compression configuration, when said first actuation piston (7) is in said first actuation position, in which said second elastic member (27) is provided with a second radial overall dimension greater than said first radial overall dimension and with a second axial overall dimension smaller than said first axial overall dimension so as to interfere with said second lateral surface (26) and push said locking portion (21) into said expanded configuration.

7. The clamping device according to claim 6, wherein said second elastic member (27) comprises at least one second belleville washer (33).

8. The clamping device according to claim 7, wherein said at least one second belleville washer (33) extends with annular shape around an extension axis thereof that is substantially parallel to said translation direction, delimits a central opening (28) traversed by said pusher body (23) and it is provided with:
a larger base (29) thereof, which:
is arranged, directly or indirectly, resting against an abutment surface (30) extending within said containment volume (24) transversely to said second lateral surface (26), and
is in contact with said second lateral surface (26);
and with an opposite smaller base (31), which is susceptible to receive, directly or indirectly, against itself, the thrust surface (25) of said pusher body (23) in order to be actuated between said compression configuration and said release configuration.

9. The clamping device according to claim 1, wherein said first clamping assembly (2) comprises:
a third connection body (46), which is rotatably connected to said first connection body (3) around at least one rotation axis so that said first connection body (3) and said third connection body (46) are movable one with respect to the other into a plurality of second adjustment positions;
a second locking system (47), which is mechanically associated with said first connection body (3) and with said third connection body (46) and it can be switched between a second constraint condition, in which it locks said first and said third connection body (3, 46) into one of said second adjustment positions, and a second release condition, in which it frees said first and said third connection body (3, 46) to mutually rotate one with respect to the other;
a second actuation piston (48), which is slidably inserted into said first guide chamber (8) in order to translate between a third actuation position, in which it maintains said second locking system (47) in said second constraint condition, and a fourth actuation position, in which it maintains said second locking system (47) in said second release condition;
a third elastic member (50), which is inserted into said first guide chamber (8) and it is provided to force said second actuation piston (48) into one of said third actuation position and said fourth actuation position;
said first actuator (10) being provided to move said second actuation piston (48) into the other of said third and said fourth actuation position, making said third elastic member (50) yield elastically.

10. The clamping device according to 9, wherein said first actuator (10) comprises at least one first conveyance duct (32) obtained on said first connection body (3), placed in fluid communication with said first guide chamber (8) and provided to convey a pressurized fluid against said first actuation piston (7) in order to make said first elastic member (9) yield elastically and push said first actuation piston (7) into the other of said first actuation position and said second actuation position;
the first conveyance duct (32) of said first actuator (10) is provided to convey said pressurised fluid against said second actuation piston (48) so as to make said third elastic member (50) yield elastically and push said second actuation piston (48) into the other of said third actuation position and said fourth actuation position.

11. The clamping device according to claim 9, wherein said first connection body (3) is provided with a first sliding surface (52) and said third connection body (46) is provided with a second sliding surface (53);
said second locking system (47) comprising a first pulling element (58), which is mechanically associated with the third connection body (46) and it is integrally joined at least in translation with said second actuation piston (48) to pull, with said second actuation piston (48) in said third actuation position, said first sliding surface (52) in a pressurised manner, directly or indirectly, against said second sliding surface (53).

12. The clamping device according to claim 11, wherein said first sliding surface (52) and said second sliding surface (53) slide on each other with said first connection body (3) and said third connection body (46) which rotate around the at least one rotation axis;
said first pulling element (58) being integrally joined in translation with said second actuation piston (48) to pull in pressurised abutment said first sliding surface (52) against said second sliding surface (53) with said second actuation piston (48) in said third actuation position.

13. The clamping device according to claim 12, wherein one of said first sliding surface (52) and said second sliding surface (53) is concave with substantially spherical cap shape and the other of said first sliding surface (52) and said second sliding surface (53) is convex with substantially spherical cap shape, so that said first connection body (3) and said third connection body (46) are rotatably connected to each other around three mutually orthogonal rotation axes.

14. The clamping device according to claim 11, wherein said first clamping assembly (2) comprises a fourth connection body (100), which:
is interposed between said first connection body (3) and said third connection body (46),
is traversed by said first pulling element (58),
is provided with a third sliding surface (101) in contact with said first sliding surface (52) and with a fourth sliding surface (102) thereof in contact with said second sliding surface (53);
is slidably associated with said first connection body (3) along an adjustment plane (X) transversal (in particular orthogonal) to said translation direction in a plurality of third adjustment positions, and
carries rotatably mounted thereon said third connection body (46) around at least one rotation axis so that said first connection body (3) and said third connection body (46) are movable one with respect to the other into said plurality of said second adjustment positions;
said first pulling element (58) being integrally joined in translation with said second actuation piston (48) to pull, with said second actuation piston (48) in said third actuation position, said second sliding surface (53) in pressurised abutment against said fourth sliding surface (102) and said third sliding surface (101) in pressurised abutment against said first sliding surface (52).

15. The clamping device according to claim 14, wherein said first sliding surface (52) and said third sliding surface (101) are planar and coincide with said adjustment plane (X);
one of said second sliding surface (53) and said fourth sliding surface (102) being concave with substantially spherical cap shape and the other of said second sliding surface (53) and said fourth sliding surface (102) being convex with substantially spherical cap shape, so that said fourth connection body (100) and said third connection body (46) are rotatably connected to each other around three mutually orthogonal rotation axes.
